(19) United States
(12) Patent Application Publication
(10) Pub. No.: US 2017/0126908 A1
(43) Pub. Date: May 4, 2017

(54) ROBUST MESH PRINTER NETWORK WITH DISTRIBUTED QUEUE MANAGEMENT

(71) Applicant: MyQ spol. s.r.o., Prague 9 (CZ)

(72) Inventor: Jakub Ahmadyar, Prague (CZ)

(21) Appl. No.: 14/925,978

(22) Filed: Oct. 29, 2015

(51) Int. Cl. H04N 1/00; H04N 1/44; G06F 3/12

(52) U.S. Cl. CPC H04N 1/00344; G06F 3/1203; G06F 3/126; G06F 3/1288; H04N 1/4413; H04N 2201/0094; H04N 2201/0039

(57) ABSTRACT

A system for operating a robust mesh printer network with distributed queue management, comprising a print queue server that receives printer tasks via a network and maintains a print queue based on received tasks, transmits tasks via a network, and updates the print queue based on received changes and transmitted tasks, and a method for operating a robust mesh printer network with distributed queue management using a print queue server.

### CROSS-REFERENCE TO RELATED APPLICATIONS

None.

### BACKGROUND OF THE INVENTION

Field of the Art

The disclosure relates to the field of document printing, and more particularly to the field of maintaining a print queue across multiple devices.

Discussion of the State of the Art

In the art of document printing, it is common to operate a number of hardware printer devices communicating via a network for distributed completion of printer tasks, for example in an office or school environment. Generally, a user submitting a task such as a document to be printed, must select a printer for use and then retrieve their documents from that printer upon completion. In some arrangements, a print queue is maintained at a printer, and a user may authenticate their credentials via a password-based login or a swiped access card, and may then view pending print tasks and select theirs for printing. However, there is no provision for situations where the user does not know the name or network address of the printer they wish to use, or if they wish to complete printing at another time or location, for example while travelling. Additionally, if a network connection is lost between a printer and a print server, a queue cannot be retrieved or modified until the connection is restored.

What is needed, is a printer queuing system that maintains a user's print tasks across locations and devices, that maintains an offline queue to operate without network connectivity, and that may operate on existing multifunction devices.

### SUMMARY OF THE INVENTION

Accordingly, the inventor has conceived and reduced to practice, in a preferred embodiment of the invention, systems and methods for operating a robust mesh printer network with distributed queue management, that may operate on existing multifunction devices, and that operates a printer queue that may be shared across devices with or without a server connection.

According to a preferred embodiment of the invention, a system for operating a robust mesh printer network with distributed management, comprising a print queue server comprising at least a plurality of programming instructions stored in a memory and operating on a processor of a computing device and configured to receive at least a plurality of printer tasks via a network, and configured to produce a printer queue comprising at least an ordered list of printer tasks, the printer queue based at least in part on at least a portion of the received tasks, and configured to transmit at least a plurality of printer tasks via a network, the transmitted tasks based at least in part on at least a portion of the printer queue, is disclosed.

According to a further embodiment of the invention, a method for operating a robust mesh printer network with distributed management, comprising the steps of receiving, at a print queue server comprising at least a plurality of programming instructions stored in a memory and operating on a processor of a computing device and configured to receive at least a plurality of printer tasks via a network, and configured to produce a printer queue comprising at least an ordered list of printer tasks, the printer queue based at least in part on at least a portion of the received tasks, and configured to transmit at least a plurality of printer tasks via a network, the transmitted tasks based at least in part on at least a portion of the printer queue, a plurality of printer tasks; producing a printer queue based at least in part on at least a portion of the received printer tasks; upon interaction from a user, transmitting at least a portion of printer tasks to a printer device for printing, the portion being based at least in part on at least a portion of the user interaction; and removing at least a portion of the transmitted printer tasks from the printer queue, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for operating a robust mesh printer network with distributed queue management, according to a preferred embodiment of the invention.

FIG. 6 is a block diagram of a further exemplary system architecture, illustrating terminal communication in greater detail.

FIG. 7 is a block diagram of a further exemplary system architecture, illustrating the use of email and active directory connectivity.

FIG. 8 is a block diagram of a further exemplary system architecture, illustrating the use of master and site servers.

FIG. 9 is a method flow diagram, illustrating an exemplary method for operating a robust mesh printer network with distributed queue management.

FIG. 10 is a message flow diagram, illustrating an exemplary arrangement of a plurality of print queueing systems operating on separate multifunction devices, and the message interactions between them to maintain synchronized print queues via mesh networking

### DETAILED DESCRIPTION

The inventor has conceived, and reduced to practice, in a preferred embodiment of the invention, systems and methods for operating a robust mesh printer network with distributed queue management, that may operate on existing multifunction devices, and that operates a printer queue that may be shared across devices with or without a server connection.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

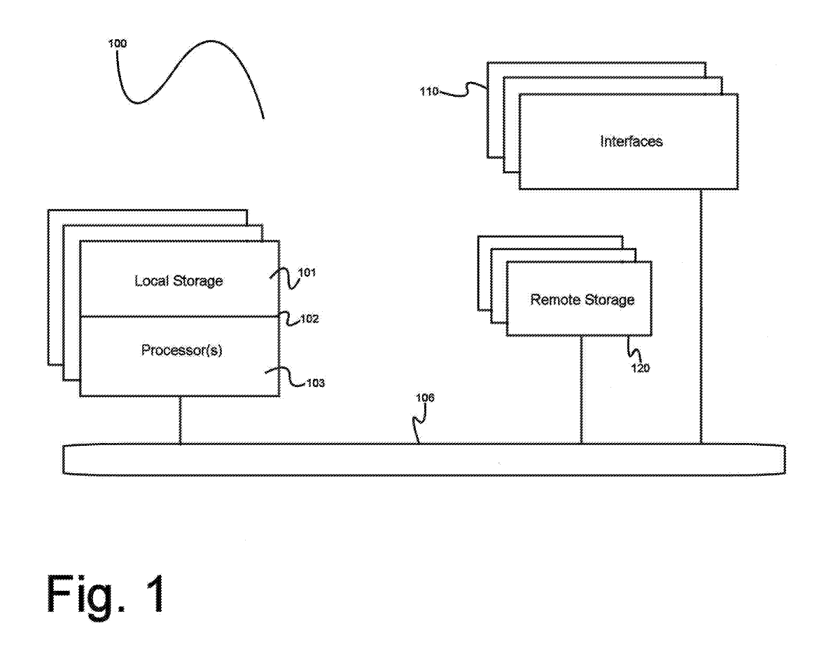

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

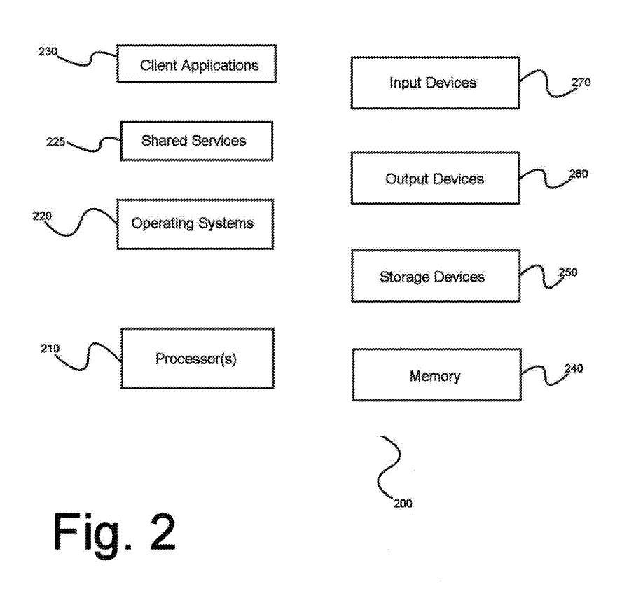

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

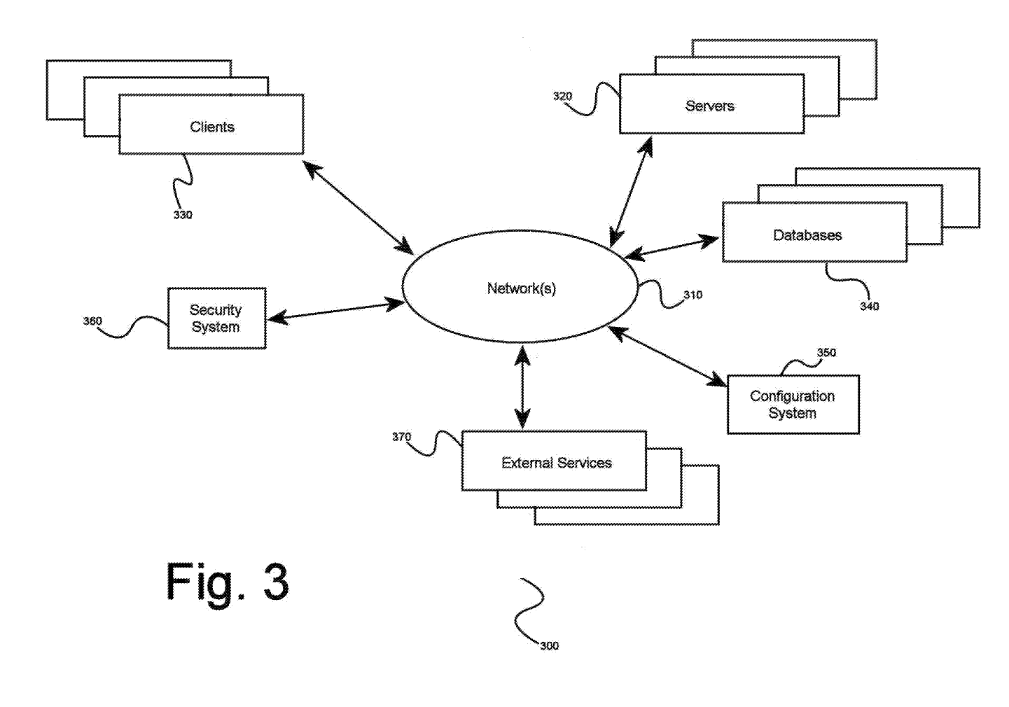

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

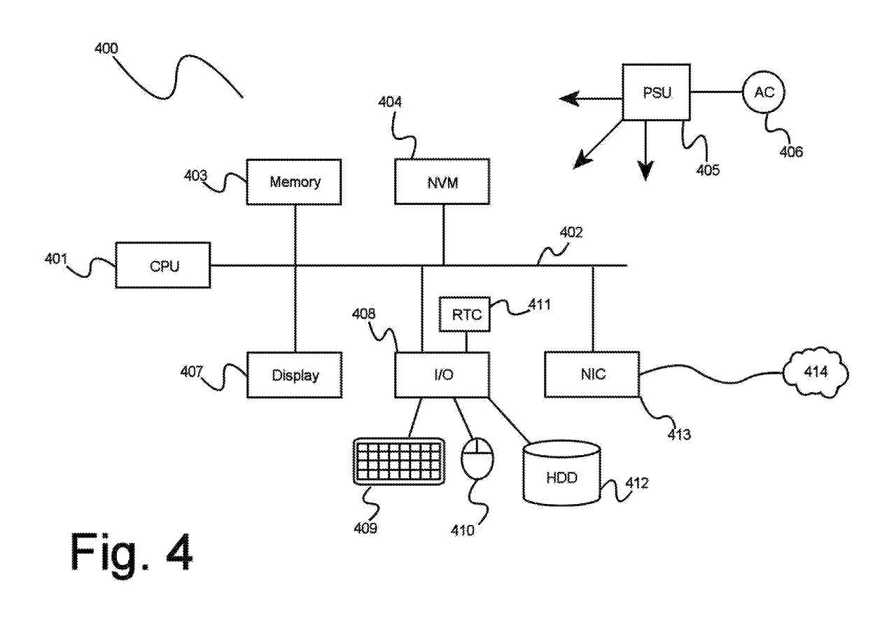

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. Central processor unit (CPU) 401 is connected to bus 402, to which bus is also connected memory 403, nonvolatile memory 404, display 407, input/output (I/O) unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to a main alternating current (AC) supply 406. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

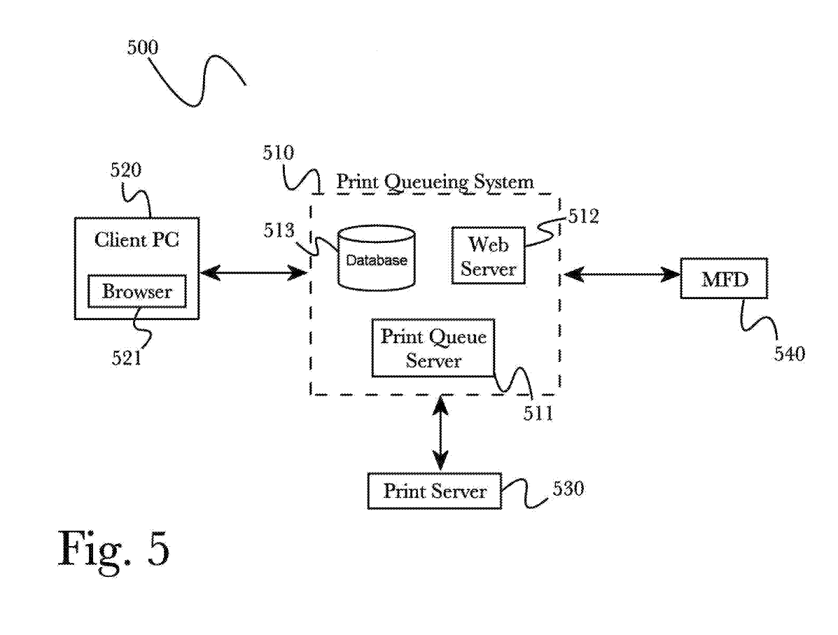

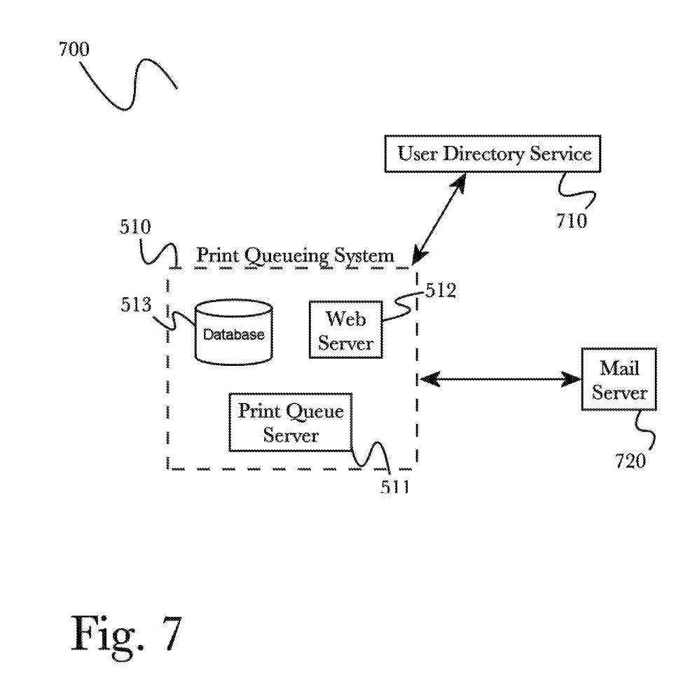

FIG. 5 is a block diagram of an exemplary system architecture 500 for operating a robust mesh printer network with distributed queue management, according to a preferred embodiment of the invention. According to the embodiment, a print queueing system 510 may comprise a plurality of programming instructions configured to be installed on and operated by a multifunction device (MFD), for example as used to perform a variety of scanning, printing, or other tasks in a workplace. Print queueing system 500 may comprise a print queue server 511 that may receive a plurality of printer tasks such as documents for printing or maintenance tasks like cartridge replacement or head cleaning, and may associate specific jobs with identifying information for queueing such as timestamps (to maintain a time-based queue) or authentication information for specific users (as described below, referring to FIG. 7) to associate tasks with a user that submitted them for queueing. A web server 512 may be used to provide an interactive interface accessible via a web browser over a network, for example to configure operation or to view or edit queued printer tasks (for example, for a user to log in using their credentials and view all tasks associated with their account so they may cancel or pause tasks, or verify whether a task is still in the queue), or to receive instructions in a non-graphical format such as might be sent in an email or text message from a user on a mobile device (for example, using specific formatting or a special destination address), and a database 512 may be used to store and provide queued tasks and other information for operation. Print queueing system 510 may receive interaction from a client computing device 520 (for example, a user transmitting print tasks from their personal computer or smartphone), as well as from a print server 530 such as to receive print tasks from multiple devices after they have been processed and “spooled” by a print server 530 for transmission to print queueing system 510, for example in an office building where many computers may send tasks to a central print server for processing. Queued tasks may then be transmitted to a plurality of connected MFDs 540, for example by sending specific tasks to specific printers based on such information as location or production capacity (for example, sending large documents to a printer with more ink or paper), or distributing print tasks across many printers to complete them in a more efficient manner.

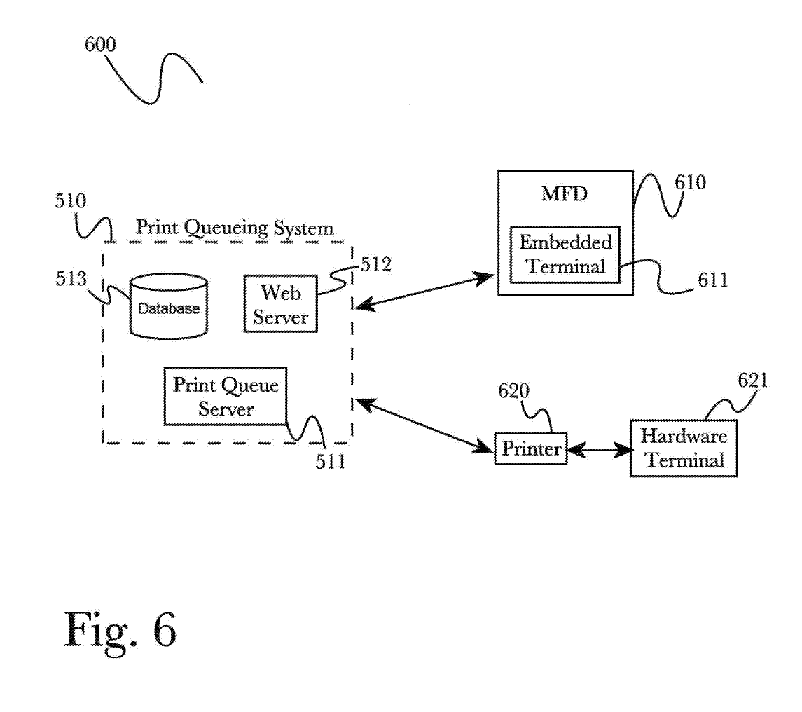

Additionally, an MFD 540 may operate its own printer queue (for example, as a component of a configured print queueing server operating on the MFD 540), which may be synchronized with a queue operating on a print queue server 511 such that as print tasks are completed they are removed from both queues, and as new jobs are added they are “pushed” to both queues, so that at any given time all synchronized print queues reflect the same queued tasks. This push functionality may be used to maintain a distributed print queue across multiple printers or MFDs, for example by synchronizing through a single print queue server 511 or by synchronizing between multiple individual MFDs each operating their own print queueing system 510 so that a user can submit a printer tasks to a queue regardless of their location or to which MFDs or printers they have an available connection (for example, if only a subset of all connected MFDs are viewable by that particular user or compatible with their current device), and then at their convenience access and complete that task from any connected printer. For example, an MFD 540 may operate a user authentication terminal (as described below in greater detail, referring to FIG. 6), and a user may authenticate at the terminal to view their current print tasks and select one or more for completion. Until a user manually authenticates and completes a task, it may be stored in a queue indefinitely or for a preconfigured length of time (for example, a queue may be configured to remove tasks after a one-week expiration period), so users may submit multiple tasks and complete them as desired without losing track of what work has already been submitted.

According to the embodiment, a client computer 520 may be any computing device configured to produce and transmit printing tasks, for example a personal computer, smartphone, or tablet computing device. Client 520 may operate a web browser 521 software application, that may be used by a user to interact with an interface operating on a web server 512, for example to view or modify their print tasks.

### Detailed Description of Exemplary Embodiments

FIG. 6 is a block diagram of a further exemplary system architecture 600, illustrating terminal communication in greater detail. According to the embodiment, a print queueing system 510 operating on an MFD as described above (referring to FIG. 5) may transmit print tasks to an MFD 610 that comprises an embedded authentication terminal 611 for user authentication (for example, an MFD that comprises a printer, scanner, and a card reader for users to swipe or scan an ID card such as an employee or student ID badge). Using terminal 611, users may verify their account or other credentials (for example, using a card reader to scan an employee or student ID card to authorize the user for printer use), and upon verification they may view, modify, or complete print tasks as desired. For example, a user may have several pending tasks in a print queue operating on a print queue server 511 (for example, operating on an MFD communicating via a network), and they may then verify their identity at any connected printer, review their queued tasks, remove any tasks they no longer need to print, and then select tasks to print and mark as “complete”, removing them from the queue. In an alternate arrangement according to the embodiment, a connected printer 620 (that may optionally be a simple printer or an MFD configured to perform additional tasks other than printing alone) may utilize an attached hardware terminal 621 for user authentication, such as a removable card reader or keypad connected via USB, or a single terminal that may be connected to a number of printers (for example, in an arrangement where users authenticate upon entering a room of printers, then interact with the particular printer of their choosing).

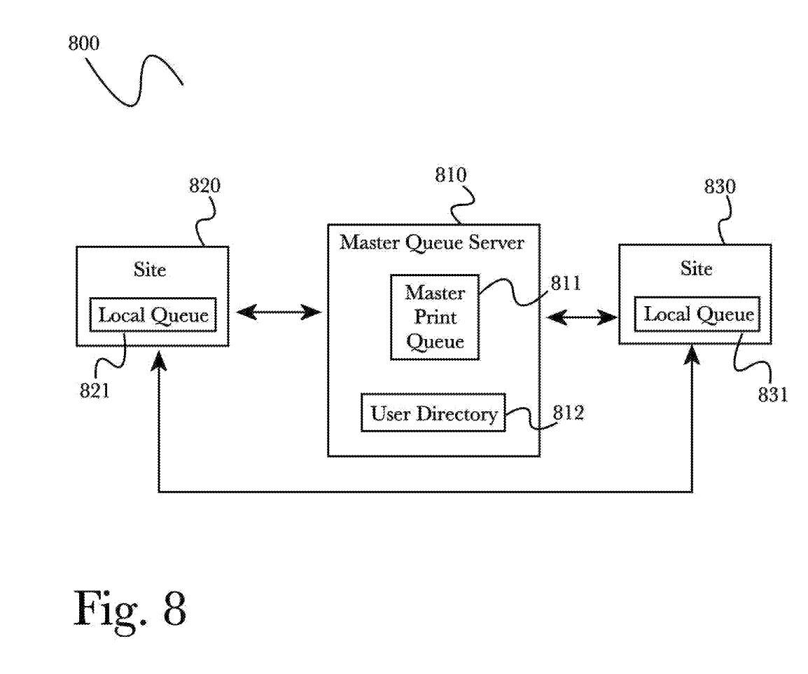

FIG. 7 is a block diagram of a further exemplary system architecture 700, illustrating the use of email and active directory connectivity. According to the embodiment, a print queueing system 500 operating on an MFD may be connected to a software-based user directory 710 such as Microsoft ACTIVE DIRECTORY™ or a lightweight directory access protocol (LDAP) system. Such user directory systems may be used to operate a directory of known users with various account attributes such as passwords, contact information, relationships with other users (for example, family members, department staff, or other relationships), or user authorization details (for example, a user may be authorized to use certain devices but not others, or to access certain documents). Using a user directory 710, a central repository of user identities may be used to authenticate users (as described above, referring to FIG. 6), and may be connected to other directory-connected systems (as is common in enterprise arrangements, where many internal services use a central user directory for authentication or authorization). If a user frequently authenticates using the same terminal or MFD, that device may be assigned as that user's “delegate” print queue. A delegate print queue for a user may be treated as a user's master print queue (as discussed below, referring to FIG. 8), and may optionally authenticate that user implicitly such as at a user's home print server, where they may be implicitly authenticated at all times and not need to repeatedly authenticate on a device that may be unusable by other persons due to physical isolation of other authentication such as at the network level or to log in on their personal computer. Additionally, a connected mail server 720 may be used to provide email capability, for example to send and receive print tasks via email communication. For example, a user may view a queued print task they submitted, and select to email the task to a contact so that their contact may also view and complete the task (for example, to share identical printed copies of a document), or so that their contact may complete the task on their behalf, for example if the only printer accessible to the user has run out of ink. Additionally, printer tasks may be received via email, for example a user may email documents to mail server 720 (for example, using a specific email address for a print queue to identify print tasks from other email traffic) to queue it for later completion.

FIG. 8 is a block diagram of a further exemplary system architecture 800, illustrating the use of master and site servers. According to the embodiment, a “master” queue server 810 may operate as a central or primary server, operating services such as (for example) a print queue 811 and user directory 812, and optionally a number of additional services or products according to a particular arrangement. Users may be authenticated against a user directory 812 and new print tasks added to a queue 811, and then copies of these master records may be transmitted to a plurality of printer sites 820, 830 such as (for example, including but not limited to) a print queue server operating on an MFD communicating via a network, or an employee's home print server. When a user connects to a site 820, they may authenticate (for example, using either a local user account at that site or by authenticating against a central user directory 812) and view print tasks stored in a local queue 821, viewing a duplicate copy of their tasks from a master queue 811. These local copies may be kept up to date by a master, using a push functionality as described previously (referring to FIG. 5) such that any updates made to a master queue 811 are immediately reflected in local copies and all available print queues reflect a similar state and queue of print tasks.

In the event that communication with a master queue is not possible, for example during a network outage or when a user is traveling and has limited connectivity, sites may communicate directly with each other to utilize mesh networking as needed, optionally communicating with a master server 810 when possible (for example, if one of the sites in communication reestablishes a connection with the master). For example, if a user submits a new print task at site 820, this task may be transmitted directly to site 830 to update a local queue 831 without connection to a master queue 811. When a connection is reestablished with the master 811, any new changes may be sent to update the master copy (and thus update any additional connected sites as needed). Additionally, a user may be able to connect to a site 820 and view print tasks in an organized fashion that indicates their origin, for example “local jobs” and “remote jobs” to reflect tasks that were submitted or received at their particular site or at another site, or received from a master queue. In this manner, a distributed printer queue may continue to function normally regardless of hardware or network failure, and users may continue to interact with a cloud queue as usual without being affected by technical complications.

Mesh networking between print queue servers may utilize push notifications or network broadcasts, for example if a queue is updated at one device (effectively functioning as the master server in this example) the changes may be broadcast so that all connected devices (that is, any that may still have a usable connection to the current master device, and that are currently listening for network events) will receive the update and implement it in their local copy of a print queue so that all available queues are synchronized. In another example, a user may authenticate at one server, and the server may then broadcast an update request to all connected devices, to verify that it has the most current queue for the user (any updates that it may not have received, for example due to being offline while updates were broadcast, will then be provided as response messages to the update request and immediately updated on a local print queue).

According to the embodiment, a site 820 that receives frequent logins from a particular user may operate as a delegate for that user. Delegate servers may function as if they were a master server on a per-user basis, receiving and transmitting print tasks to other sites as needed and being referenced by other sites as a central, authoritative copy of a user's tasks (for example, if there is a disagreement between two or more print queue servers, as may be the case if multiple MFDs go offline and a user manually updates tasks on them individually). This delegacy may be configurable by users, such as for a user to manually specify “use this printer as my delegate”, or based on configurable rules such as “automatically make delegate after 10 consecutive logins”. In this manner, printers may automatically be promoted to user delegates as needed based on user activity patterns, minimizing manual configuration while maximizing functionality. Additionally, delegacy may be automatically reassigned as needed, for example if a user's delegate server is offline and they authenticate at a different device, or if a user explicitly instructs a device to take over as their delegate. When delegacy is updated, a print queue may be transmitted from the previous delegate to the new one, so that a current queue may immediately be implemented for that user and they will not miss any tasks due to the change in devices.

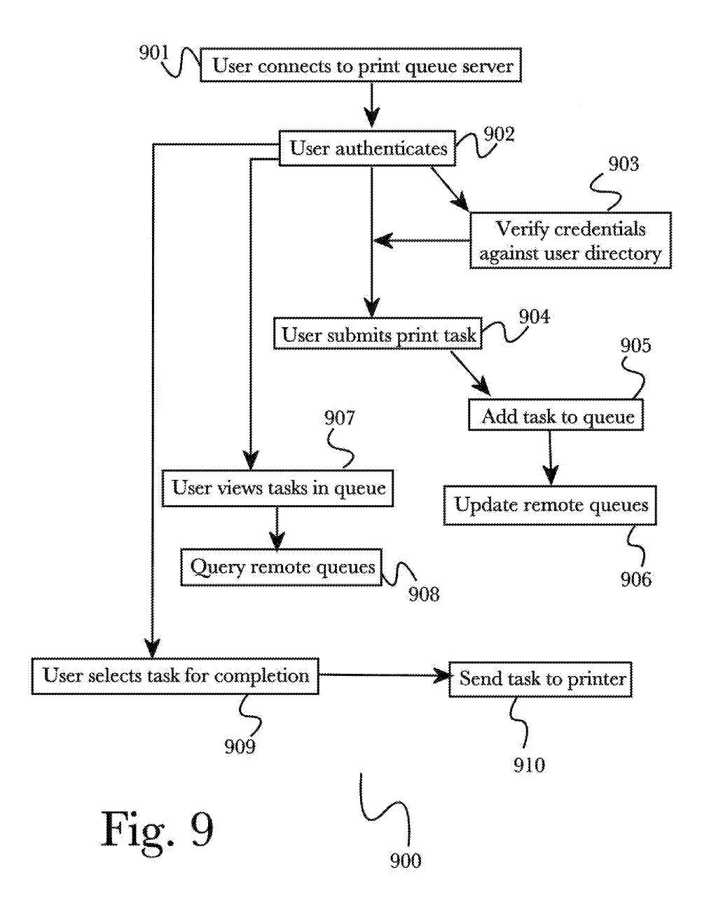

FIG. 9 is a method flow diagram, illustrating an exemplary method 900 for operation of a robust mesh printer network with distributed queue management. In an initial step 901, a user may connect to a print queue, for example via a web interface or a mobile software application, or by interacting directly with a connected printer. In a next step 902, the user may authenticate using their account credentials, for example by logging in with a username and password, or by swiping an access card, and in an optional step 903 their credentials may be authenticated against a known user directory such as LDAP or other directory system. The user may then submit a print task 904 (such as a document for printing, or a maintenance task to be performed by the printer, or other such printer jobs), and the task may then be added to a print queue 905, and optionally transmitted to any remote queues 906 to update them to reflect the now-current queue state (for example, if satellite sites are connected and maintaining offsite local queues). If the user chooses to view their current print queue it may be presented for review 907, optionally querying any remote queues 908 for example if the user chooses to “view remote tasks” or to check with a master queue for any recent changes that may not be reflected in a local queue. If the user selects a queued task to complete 909, the task may then be sent to a connected printer 910 (optionally a specific printer of the user's choosing), and removed from the queue.

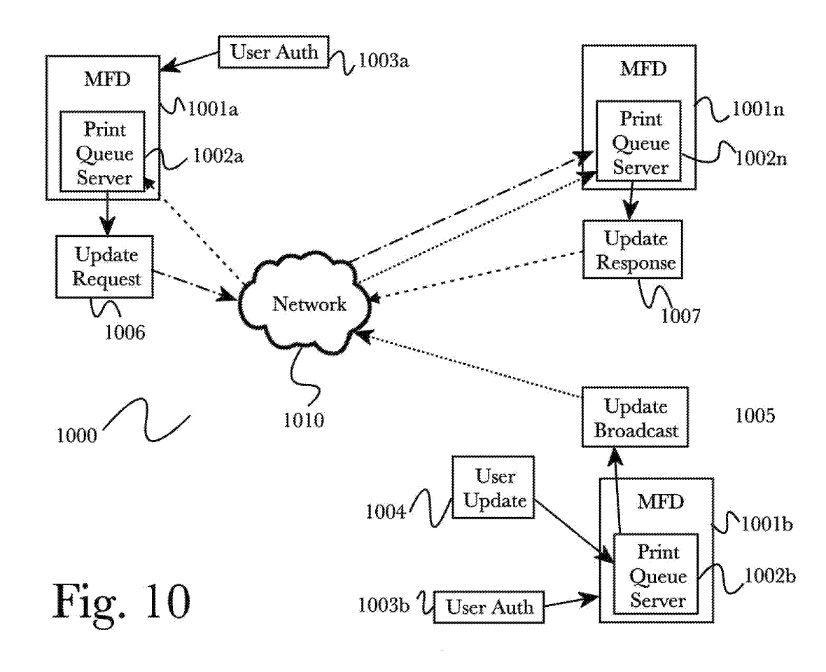

FIG. 10 is a message flow diagram, illustrating an exemplary arrangement 1000 of a plurality of print queue servers 1002a-n operating on separate multifunction devices 1001a-n, and the message interactions between them to maintain synchronized print queues via mesh networking. According to the embodiment, a user may authenticate 1003b at an MFD 1001b, and may view their tasks in a queue operated by a local print queue server 1002b. If the user chooses to submit a new task 1004 such as selecting a new document to print, local print queue server 1002b may add the updated task 1004 to a local queue and then transmit an update broadcast message 1005 to provide the details of the update to any connected print queue servers that may receive the message. As illustrated, the broadcast may be received by a print queue server 1002n operating on a connected MFD 1001n, but may not be received by a print queue server 1002a on an MFD 1001a that has lost connection at that time or is otherwise offline (for example, if it is not powered on at the time of the update). This may cause a local print queue on print queue server 1002a to become out of sync with others, due to the missing update. To fix such an out-of-sync condition, when a user authenticates 1003a at an MFD 1001a, an update request 1006 may be broadcast to check any connected servers for updates that may not be reflected in a local queue. For example, a copy of the current queue may be sent, to indicate the current state of the queue at a device 1001a, so that any receiving devices may determine the difference between the received queue state and their copy of what the state “should be”. When an update request 1006 is received by a print queue server 1002n, if a difference is determined (such as if an update 1004 was received and implemented while the requesting server 1002a was offline and is therefore not reflected in the received queue copy included with update request 1006) an update response 1007 may be transmitted, providing any details needed to modify a local queue on the requesting server 1002a to bring it in line with the current queue state. In this manner, anytime a user authenticates and views their print queue, they may be presented with the current or “most up-to-date” version of the queue, even if the device they are on has been offline for some time or if a central server is unavailable.

The skilled person will be aware of a range of possible modifications of the various embodiments described above. Accordingly, the present invention is defined by the claims and their equivalents.

1-10. (canceled)

11. A system for operating a robust mesh print management network with distributed queue management, comprising:
a plurality of participant print queue servers each comprising at least a plurality of programming instructions stored in a memory and operating on a processor of a computing device and each connected to substantially all of the others in a mesh network, and each configured to receive at least a plurality of printer tasks via a network, and each configured to maintain a print queue comprising at least an ordered list of print tasks to be performed by a plurality of print devices connected to at least one of the print queue servers, and each configured to transmit at least a plurality of locally added print tasks via the mesh network, to at least one additional participant print queue server such that all participant print queue servers maintain printer queues comprising a substantially identical and redundant list of print tasks.

12. The system of claim 11, wherein print tasks submitted to one participant print queue server may be subsequently accessed and manipulated on all participant print queue servers.

13. The system of claim 11, wherein entry of one or more additional print queue servers onto the mesh network programmatically triggers replication of the print queue of one participant print queue server to the additional print queue server or additional print queue servers.

14. The system of claim 11, wherein each participant print queue server transmits print tasks to at least one printer on the mesh network as designated by information that is part of each printer task.

15. The system of claim 11, wherein each participant print queue server broadcasts its print queue on the mesh network according to programmatically defined events and time intervals.

16. The system of claim 15, wherein participant print queue servers employ at least a portion of the print queues broadcast by other participant print queue servers to programmatically synchronize their own print queues.

17. The system of claim 11, wherein loss of communication between one or more participant print queue servers programmatically triggers reconfiguration of the mesh network to optimize communication between the remaining participant print queue servers.

18. The system of claim 11, wherein at least one participant print queue server resides on a multifunction device.

19. A method for operating a robust mesh print management network with distributed queue management, comprising the steps of:
receiving, at a participant print queue server comprising at least a plurality of programming instructions stored in a memory and operating on a processor of a computing device and connected to a plurality of other print queue servers in a mesh network, and configured to receive at least a plurality of print tasks to be performed by a plurality of print devices connected to at least one of the print queue servers via a network, and configured to produce a first print queue comprising at least an ordered list of print tasks, the first print queue based at least in part on at least a portion of the received tasks, and configured to transmit at least a plurality of print tasks via the mesh network, the transmitted tasks based the first print queue, to at least one additional participant print queue servers comprising at least a plurality of programming instructions stored in a memory and operating on a processor of one or more additional computing devices;
producing, programmatically, a plurality of substantially identical print queues on a plurality of participant print queue servers based at least in part on at least a portion of the received print tasks;
upon interaction from a user, transmitting at least a portion of print tasks to a printer for printing, the portion being based at least in part on at least a portion of the user interaction; and
removing, programmatically, at least a portion of the transmitted print tasks from each print queue on all participant print queue servers upon completion of each respective transmitted print task.

20. The method of claim 19, wherein print tasks submitted to one participant print queue server may be subsequently accessed and manipulated on all participant print queue servers.

21. The method of claim 19, wherein entry of one or more additional print queue servers onto the mesh network programmatically triggers replication of the print queue of one participant print queue server to the additional print queue server or additional print queue servers.

22. The method of claim 19, wherein each participant print queue server transmits print tasks to at least one printer on the mesh network as designated by information that is part of each print task.

23. The method of claim 19, wherein each participant print queue server broadcasts its print queue on the mesh network according to programmatically defined events and time intervals.

24. The method of claim 23, wherein participant print queue servers employ at least a portion of the printer queues broadcast by other participant print queue servers to programmatically synchronize their own print queues.

25. The method of claim 19, wherein loss of communication between one or more participant print queue servers programmatically triggers reconfiguration of the mesh network to optimize communication between the remaining participant print queue servers.

26. The method of claim 19, wherein at least one participant print queue server resides on a multifunction device.
